(19) United States
(12) Patent Application Publication
(10) Pub. No.: US 2012/0327441 A1
(43) Pub. Date: Dec. 27, 2012

(54) SCANNERS THAT DISPLAY SETTING SCREENS, IMAGE FORMING SYSTEMS COMPRISING SUCH SCANNERS, AND METHODS FOR CONTROLLING SUCH SCANNERS

(75) Inventors: Toyoshi ADACHI, Iwakura-shi (JP); Naoki NISHIKAWA, Nagoya-shi (JP)

(73) Assignee: BROTHER KOGYO KABUSHIKI KAISHA, Nagoya-shi (JP)

(21) Appl. No.: 13/429,422

(22) Filed: Mar. 25, 2012

(30) Foreign Application Priority Data
Jun. 27, 2011 (JP) 2011-141964

(51) Int. Cl. G06K 15/02

(52) U.S. Cl. 358/1.13

(57) ABSTRACT

A scanner includes a scanning device, a display, and a control device. The scanning device scans a document, The control device obtains at least one of specification information and status information corresponding to a connection-target device. The specification information may comprise information identifying available functions of the connection-target device. The status information may comprise information indicating a current status of the connection-target device. The control device controls the display to display a setting screen for a scanning and printing process, in which the scanning device scans an image on a document and sends image data corresponding to the image on the document to the connection-target device for printing, when the connection-target device is a printer. The control device determines available options for setting items displayed on the setting screen for the scanning and printing process, based on the obtained at least one of the specification information and the status information.

### CROSS-REFERENCE TO RELATED APPLICATION

This application claims priority from Japanese Patent Application No. 2011-141964, filed on Jun. 27, 2011, which is incorporated herein by reference.

### BACKGROUND OF THE INVENTION

1. Field of the Invention

The disclosure generally relates to scanners that display setting screens, image forming systems comprising such scanners, and methods for controlling such scanners.

2. Description of Related Art

A known scanner (i.e., scanning device) performs a host function and a device function. When the known scanner establishes a connection with a personal computer (“PC”), the known scanner performs various functions as a computer peripheral device in accordance with instructions provided from the PC. When the known scanner establishes a connection with a printer (i.e., printing device), the known scanner Obtains printer information from the printer. Further, the known scanner automatically sets various parameters for performing a scanning operation based on the printer information, and the known scanner performs a copying operation with the set parameters.

### SUMMARY OF THE INVENTION

Problems may arise with the known scanner. In order for the known scanner to perform a function in cooperation with the printer, it may be necessary to specify settings consistent with a performance capability of the printer in the known scanner. Although the known scanner may obtain the performance capability of the printer and may attempt to change the settings to be consistent with the performance capability of the printer, there may be a plurality of applicable setting options for the copying operation. Therefore, a user, who is unaccustomed to using computer peripheral devices, may have difficulty specifying appropriate settings in the known scanner, Accordingly, a need to improve the usability of the known scanner has arisen.

A need has arisen for a scanning device and an image forming system that overcome these and other shortcomings of the related art. Embodiments may provide for image forming systems and scanning devices, in which settings consistent with a performance capability of a connection-target device readily may be specified.

According to an aspect of the invention, a scanner described herein may be configured to establish a connection with a connection-target device. The scanner may comprise a scanning device, a display, and a control device. The scanning device may be configured to scan a document. The control device may be configured to obtain at least one of specification information and status information corresponding to a connection-target device. The specification information may comprise information identifying available functions of the connection-target device. The status information may comprise information indicating a current status of the connection-target device. The control device may be configured to control the display to display a setting screen for a scanning and printing process, in which the scanning device may be configured to scan an image on a document and to send image data corresponding to the image on the document to the connection-target device for printing, when the connection-target device is a printer. The control device may be configured to determine one or more available options for at least one of a plurality of setting items displayed on the setting screen for the scanning and printing process, based on the Obtained at least one of the specification information and the status information corresponding to the connection-target device.

According to another aspect of the invention, an image forming system described herein may comprise a connection-target device and a scanner. The scanner may be configured to establish a connection with the connection-target device. The scanner may comprise a scanning device, a display, and a control device. The scanning device may be configured to scan a document. The control device may be configured to obtain at least one of specification information and status information corresponding to the connection-target device. The specification information may comprise information identifying available functions of the connection-target device. The status information may comprise information indicating a current status of the connection-target device. The control device may be configured to control the display to display a setting screen for a scanning and printing process, in which the scanning device may be configured to scan an image on a document and to send image data corresponding to the image on the document to the connection-target device for printing, when the connection-target device is a printer. The control device may be configured to determine one or more available options for at least one of a plurality of setting items displayed on the setting screen for the scanning and printing process, based on the obtained at least one of the specification information and the status information corresponding to the connection-target device.

According to yet another aspect of the invention, a method described herein may be for controlling a scanner that may comprise a scanning device and may be configured to establish a connection with a connection-target device. The method may comprise obtaining at least one of specification information comprising information identifying available functions of a connection-target device and status information comprising information indicating a current status of the connection-target device. The method may comprise controlling a display to display a setting screen for a scanning and printing process, in which a scanning device may scan an image on a document and may send image data corresponding to the image on the document to the connection-target device for printing, when the connection-target device is a printer. The method may comprise determining one or more available options for at least one of a plurality of setting items displayed on the setting screen for the scanning and printing process, based on the obtained at least one of the specification information and the status information.

In scanners disclosed herein, one or more available options on the setting screen for the scanning and printing process may be determined, based on the connection-target device. This configuration may facilitate identification of setting items that may be changed. The configuration described above may reduce instances of undesireable output results, based on inputted options corresponding to unavailable functions. In addition, the configuration described above may reduce or eliminate confusion caused by such problems.

According to the aspects of the disclosure, image forming systems, scanners, and methods of controlling such scanners may he implemented, such that settings consistent with the performance capability of the connection-target device readily may be specified.

Other objects, features, and advantages will be apparent to persons of ordinary skill in the art from the following detailed description of embodiments of the invention and the accompanying drawings.

### BRIEF DESCRIPTION OF THE DRAWINGS

For a more complete understanding of the present invention, needs satisfied thereby, and the objects, features, and advantages thereof, reference now is made to the following descriptions taken in connection with the accompanying drawings.

FIG. 1 is a block diagram depicting an electric configuration of a scanner and a printer in embodiments of the invention.

FIG. 2 is a flowchart of an external connection establishing process performed in the scanner according to FIG. 1.

FIG. 3 depicts an exemplary printer interface displayed within a setting screen on an operating panel of the scanner according to FIG. 1.

FIG. 4 depicts an exemplary PC interface displayed within a setting screen on an operating panel of the scanner according to FIG. 1.

FIG. 5 is a flowchart of a printer interface displaying process performed in the scanner according to FIG. 1.

FIG. 6 depicts examples of specification information, status information, and a functional profile of a printer A according to FIG. 1.

FIG. 7 depicts examples of specification information, status information, and a functional profile of a printer B according to FIG. 1.

FIG. 8 depicts an exemplary transfer function interface displayed within a setting screen on an operating panel of the scanner according to FIG. 1.

FIG. 9 depicts an exemplary facsimile transfer function interface displayed within a setting screen on an operating panel of the scanner according to FIG. 1.

FIG. 10 depicts an exemplary electronic mail transfer function interface displayed within a setting screen on an operating panel of the scanner according to FIG. 1.

FIG. 11 is a flowchart of a copying function interface displaying process performed in the scanner according to FIG. 1.

FIG. 12 depicts an exemplary option profile of printer A according to FIG. 1.

FIG. 13 depicts an exemplary option profile of printer B according to FIG. 1.

FIG. 14 depicts an exemplary screen display of a copying function interface fur printer A according to FIG. 1.

FIG. 15 depicts an exemplary screen display of a copying function interface for printer B according to FIG. 1.

### DETAILED DESCRIPTION OF EMBODIMENTS OF THE INVENTION

Embodiments in which a scanning device according to one or more aspects of the disclosure is implemented now are described with reference to the accompanying drawings, like numerals being used for like corresponding parts in the various drawings. In embodiments, one or more aspects of the disclosure may be applied to a mobile scanner, which may be configured to establish a. connection with a. printer and to provide instructions to the printer directly.

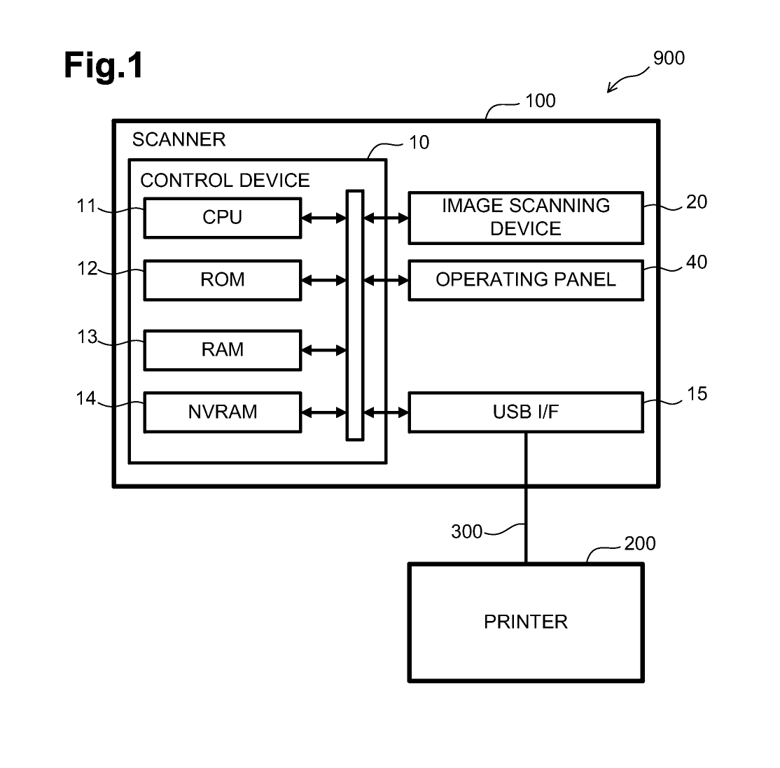

As depicted in FIG. 1, a scanner 100 may comprise an image scanning device 20 (e.g., a scanning device), an operating panel 40 (e.g., a display), a control device 10, and a Universal Serial Bus (“USB”) interface (“I/F”) 15. Image scanning device 20 may be configured to scan an image on a document. Operating panel 40 may be configured to display an operation screen thereon for accepting a user input. Control device 10 may be configured to control image scanning device 20 and operating panel 40. USB interface 15 may serve as a communication interface for establishing a connection with an external device. Control device 10 may comprise a. central processing unit (“CPU”) 11, a read-only memory (“ROM”) 12, a random-access memory (“RAM”) 13, and a nonvolatile random-access memory (“INVRAM”) 14.

Scanner 100 may be configured to establish a connection with various types of devices and perform functions that may be appropriate to a device that is connected to scanner 100. FIG. 1 depicts an image forming system 900, in which scanner 100 and a printer 200 may be connected to each other via, a USB cable 300. Scanner 100 may be configured to handle various types of printers (e.g., printer 200) and may provide printer 200 with an instruction that may be appropriate to connected printer 200. Scanner 100 may be configured to establish a connection to other information equipment (e.g., PCs or smartphones), which scanner 100 may identify, as well as printers,

For example, ROM 12 may store firmware, which may comprise control programs for controlling scanner 100, various settings, and certain initial values. RAM 13 may be used as a work area for storing various control programs read from ROM 12 or as a storage area for temporarily storing image data.

CPU 11 may be configured to control functions of each device comprised in scanner 100. CPU 11 may store processing results in one or more of RAM 13 and NVRAM 14 in accordance with control programs read from ROM 12 and signals sent from sensors.

USB interface 15 may be configured to provide a communication pathway for scanner 100 to communicate with an external device. Scanner 100 may be configured to output an instruction to the external device and to receive an instruction from the external device, via USB interface 15. The connection between scanner 100 and the external device may be established through alternative communication pathways, rather than through USB interface 15. In certain embodiments, for example, scanner 100 may comprise a network interface. When scanner 100 comprises the network interface, scanner 100 may establish a connection with the external device via, the network interface. When scanner 100 comprises a wireless communication interface, scanner 100 may establish a connection with the external device via the wireless communication interface.

Image scanning device 20 may comprise an image sensor configured to scan a document. Image scanning device 20 may be configured to output an image of the scanned document as image data in portable document format (“PDF”) to one or more of NVRAM 14 in scanner 200 and the external device connected with scanner 100 via USB interface 15.

Operating panel 40 may comprise various graphics that operate as virtual buttons and keys (e.g., power button and numeric keys) and a touch-screen display, such as a touch-screen, liquid crystal display (“LCD”). Operating panel 40 may be configured to display a setting screen. for performing various settings on the LCD and may receive a user input therethrough. The input may be implemented by directly touching the LCD using one or more of the various graphics that operate as virtual buttons and keys, In alternative configurations, the input may be implemented by touching one or more of physical buttons and keys corresponding to the graphics.

More specifically, scanner 100 may be configured to obtain a type of a connection-target device and to display a setting screen, which is appropriate to the type of the connection-target device, on the LCD of operating panel 40 when scanner 100 performs functions in cooperation with the connection-target device. Scanner 100 subsequently may accept settings related to the functions that may be input. In image forming system 900, as depicted in FIG. 1, scanner 100 may be configured to identify the connection-target device as a printer and to identify functions that are available in printer 200, and scanner 100 subsequently may display a setting screen appropriate to printer 200.

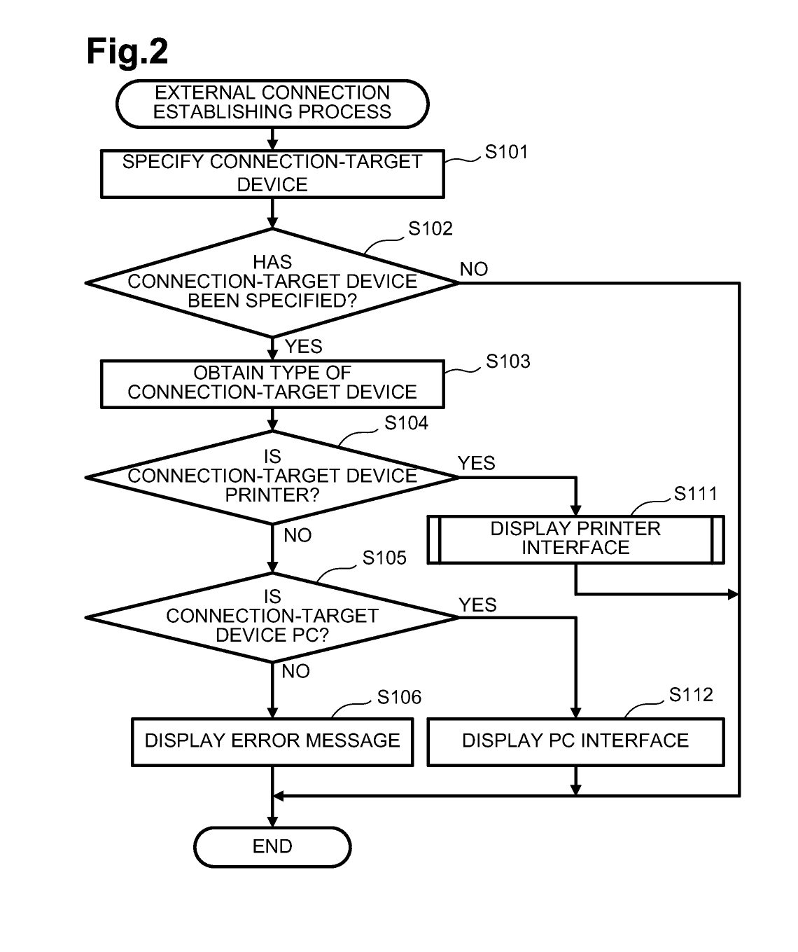

An external connection establishing process now is described with reference to FIG. 2. In the external connection establishing process, scanner 100 may provide an instruction to a connection-target device of scanner 100. The external connection establishing process may be performed by CPU 11 when scanner 100 receives, via operating panel 40, an instruction to start communicating with the external device (e.g., a communication start instruction). The communication start. instruction may be provided by inputting the communication start instruction through, for example, one or more of a communication start graphic disposed on the LCD of operating panel 40 and a communication start switch disposed on operating panel 40.

CPU 11 may specify a connection-target device at step S101. For example, CPU 11 may display on operating panel 40 a screen for accepting directly an input of, for example, one or more of an IP address the connection-target device and a node name of the connection-target device. When scanner 100 establishes a connection with the external device via a network, CPU 11 may broadcast a connection request signal to external devices located on the same network. CPU 11 subsequently may display a list of external devices to which scanner 100 may connect, which may be based on response signals from the external devices, such that a connection-target device may be selected. When scanner 100 establishes a connection with an external device via a USB cable, CPU 11 may recognize a connection-target device, and CPU 11 may automatically specify the recognized external device as a connection-target device.

CPU 11 may determine whether a connection-target device has been specified at step S102. When CPU 11 has received a cancel instruction without a connection-target device specified (step S102:NO), CPU 11 may end the external connection establishing process. When CPU 11 determines that a connection-target device has been specified (step S102:YES), CPU 11 may obtain a type of the specified connection-target device by sending an inquiry to the specified connection-target device at step S103. More specifically, CPU 11 may obtain the type of the specified connection-target device, which may comprise information for identifying the external device as one of a printer, a PC, and another device. When CPU 11 already has obtained the type of the connection-target device before step S103, CPU 11 may skip step S103 and proceed to step S104.

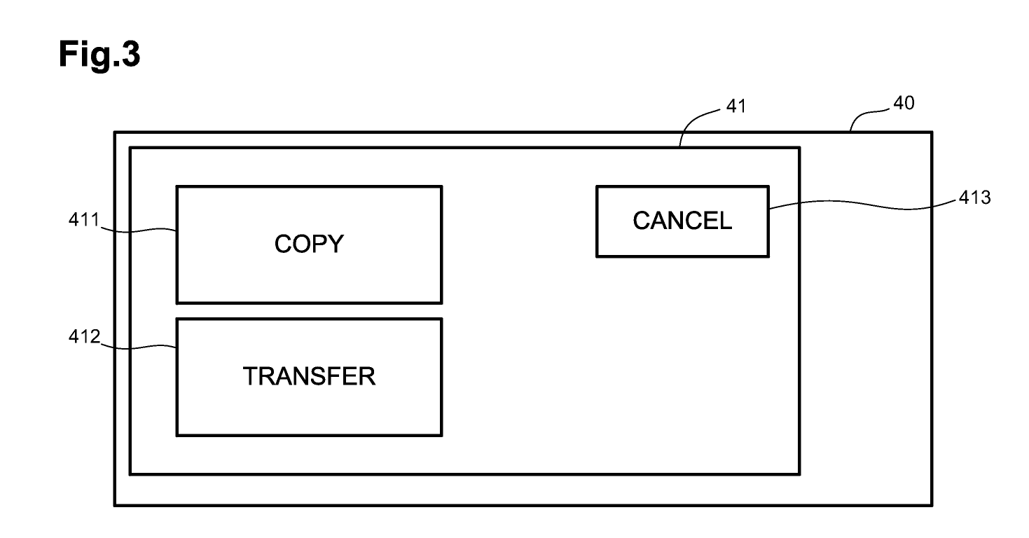

CPU 11 may determine whether the connection-target device specified in step S101 is a printer at step S104. In step S104, CPU 11 may identify the connection-target device as a printer when the connection-target device comprises a printing function. CPU 11 also may identify devices (e.g., multifunction peripherals or facsimile machines) other than print-dedicated devices as printer devices if those devices comprise the printing function, When the connection-target device is a printer (step S104:YES), CPU 11 may perform a printer interface displaying process for displaying a printer setting screen printer interface 41) on operating panel 40 at step S111, as depicted in FIG. 3.

Operating panel 40 may display a setting screen comprising printer interface 41 that may permit the selection of one of a copying function (e.g., a function in which scanner 100 may scan an image on a document and printer 300 subsequently may print the scanned image) and a transfer function (e.g., a function in which scanner 100 may scan an image on a document and subsequently may transfer a file of a scanned image via printer 200). More specifically, printer interface 41 may comprise a copy graphic 411, a transfer graphic 412, and a cancel graphic 413, as depicted in FIG. 3. Selecting copy graphic 411 may initiate the copying function. Selecting transfer graphic 412 may initiate the transfer function. Selecting cancel graphic 413 may cancel the external connection establishing process. As depicted in FIG. 3, printer interface 41 may be an example of the printer setting screen, and printer interfaces disclosed herein may not be limited to the configuration of printer interface 41 described above. In certain embodiments, the printer setting screen may comprise other graphics for implementing other functions, Step S111 is described below in detail.

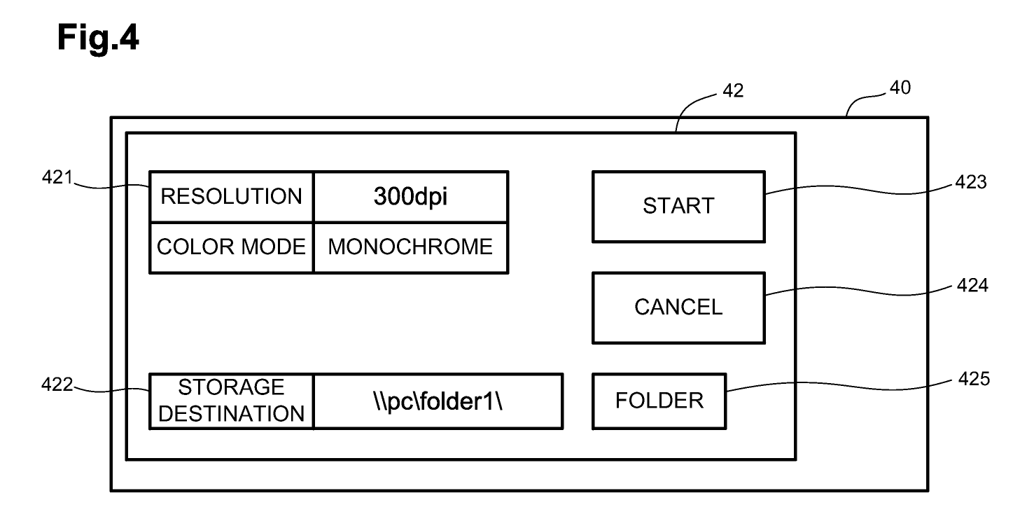

When the connection-target device is not a printer (step S104:NO), CPU 11 may determine whether the connection-target device is a PC at step S105. When the target device is PC (step S105:YES), CPU 11 may display a setting screen for a scanning and storing process (e.g., PC interface 42) on operating panel 42 at step S112, as depicted in FIG. 4.

Operating panel 40 may display a setting screen comprising PC interface 42 that may permit the selection of settings for a process in which scanner 100 may scan a document and store an image scanned from the document a scanned image) in a connection-target device. More specifically, PC interface 42 may comprise a scan settings area 421, a storage settings area 422, a start graphic 423, a cancel graphic 424, and a folder graphic 425. Scan settings area 421 may be used for setting the scan settings. Storage settings area 422 may be used for setting the storage settings. Start graphic 423 may be for starting scanning of a document. Cancel graphic 425 may be for cancelling the external connection establishing process. Folder graphic 425 may be for selecting a storage destination folder from a folder list or creating a new folder. As depicted in FIG. 4, PC interface 42 may be an example of the setting screen for the scanning and storing process and may not be limited to the configuration of PC interface 42 described above. In certain embodiments, for example, the setting screen for the scanning and storing process may comprise other graphics for implementing other functions.

Scan settings area 421 may indicate the currently-selected option for each item listed in the scan settings (e.g., items, such as resolution and color mode). When an input operation (e.g., touching a display area on operating panel 40) is performed to select one of the items listed in Sean settings area 421, another option may appear for the selected item, instead of the currently selected option. When an input operation is performed to select “resolution,” for example, the currently-selected option for a resolution may be changed to another option supported by scanner 100. When an input operation is performed to select “color mode,” for example, the currently-selected option for a color mode may be changed to another option. When the currently-selected option for the color mode is “monochrome,” for example, another option (e.g., “color”) may appear next. When the currently-selected option for the color mode is “color,” another option (e.g., “monochrome”) may appear next. The options available for each item may be determined based on the functions of scanner 100.

When the connection-target device is not a PC (step S105:NO), CPU 11 may display on operating panel 40 an error message indicating that the type of the connection-target device is unknown at step S106. Thus, the error message may indicate that the specified connection-target device is not appropriate for connecting and cooperating with scanner 100.

After each of steps S111, S112, and S106, CPU 11 may end the external connection establishing process. As described above, in the external connection establishing process, CPU 11 may determine an appropriate setting screen to be displayed on operating panel 40 in accordance with the type of the connection-target device. Thus, setting screen displayed on operating panel 40 may indicate to the user that scanner 100 is connected with one of a printer and a PC.

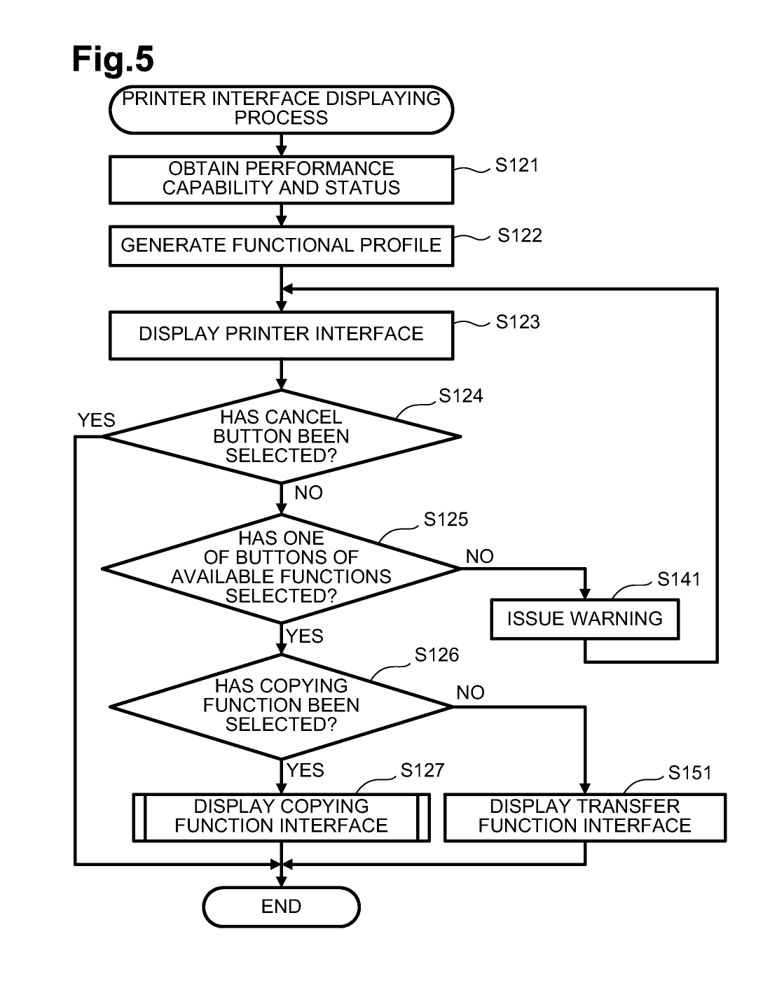

The printer interface displaying process of step S111 of FIG. 2 now is described in more detail, with reference to FIG. 5. CPU 11 may perform the printer interface displaying process.

CPU 11 may obtain performance capability data (hereinafter, Obtained performance capability data is referred to as “specification information”) and status data (hereinafter, obtained status data is referred to as “status information”) related to the connection-target device at step S121. More specifically, CPU 11 may request the connection-target device to provide performance capability data and status data, and CPU 11 may obtain the specification information and the status information based on a response from the connection-target device. CPU 11 may store and maintain the specification information and status information in one or more of RAM 13 and NYRAM 14. CPU 11 may obtain the specification information and the status information simultaneously or separately.

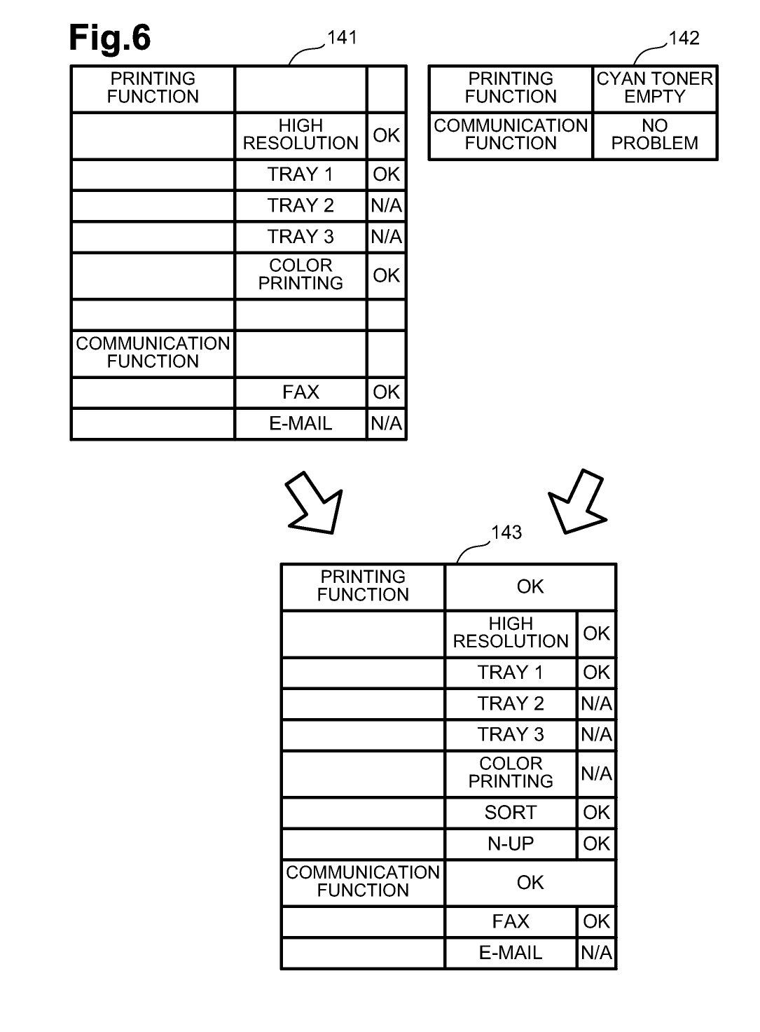

CPU 11 subsequently may generate a functional profile comprising information regarding the availability of functions in the connection-target device, based on the specification information and status information obtained from the connection-target device at step S122. FIG. 6 depicts a situation, in which CPU 11 has obtained specification information 141 and status information 142 from a connection-target device of a model A (hereinafter, referred to as a “printer A”). Specification information 141 may identify whether certain functions are available in printer A. In FIG. 6, the term: “OK” may indicate that the function is available for use in printer A, and the term: “N/A” may indicate that the function is not available for use in printer A. Status information 142 may indicate the current status of the connection-target device. In FIG. 6, the term: “NO PROBLEM” may indicate that a function currently operates with no problems, and the character: “-” depicted in FIG. 6) may indicate that the connection-target device does not support the function. When an error has occurred in the connection-target device, status information 142 may comprise details of the error. CPU 11 may generate a functional profile 143 based on the obtained specification information 141 and status information 142. In functional profile 143, the term: “OK” may indicate that the function is available for use in printer A, and the term: “N/A” may indicate that the function is not available for use in printer A.

More specifically, according to FIG. 6, CPU 11 may determine from specification information 141 of printer A that a high resolution, a tray 1, and color printing may be available printing functions of printer A and that a facsimile function may be an available communication function of printer A. Further, according to FIG. 6, CPU 11 may determine from status information 142 that the communication function currently may operate with no problems, but that the printing function has a problem, namely, that the Cyan toner is empty. CPU 11 also may determine that the color printing option is not available because of empty of cyan toner. As described above, certain functions may not be available based on conditions of the connection-target device, even though the connection-target device may support the function is supported by (e.g., color printing in printer A). Therefore, CPU 11 may determine the availability of each function based on both specification information 141 and status information 142. Consequently, according to FIG. 6, in functional profile 143, CPU 11 may assign the term: “OK” to the available options (e.g., high resolution, tray 1, and facsimile function), and CPU 11 may assign the term: “N/A” to the unavailable options tray 2, tray 3, color printing, and electronic mail function). When the printing function is available in the connection-target device, CPU 11 may assign the term: “OK” to the printing function. When the printing function is not available in the connection-target device, CPU 11 may assign the term: “N/A” to the printing function. In functional profile 143, CPU 11 may assign the term: “OK” to the printing function because monochrome printing is available in printer A. When the connection-target device has at least one available option in the communication function, CPU 11 may assign the term: “OK” to the communication function. When the connection-target device does not have an available option in the communication function, CPU 11 may assign the term: “N/A” to the communication function. In functional profile 143. CPU 11 may assign the term: “OK” to the communication function because the facsimile function may be available in printer A.

Functional profile 143 also may indicate functions that do not depend on printer information (e.g., specification information 141 and status information 142) in addition to the above-described functions. For example, scanner 100 may implement one or more of a sorting function and an N-up printing function during image processing. Therefore, CPU 11 may add the sorting function and the N-up printing function to functional profile 143 as available functions, regardless of the printer information.

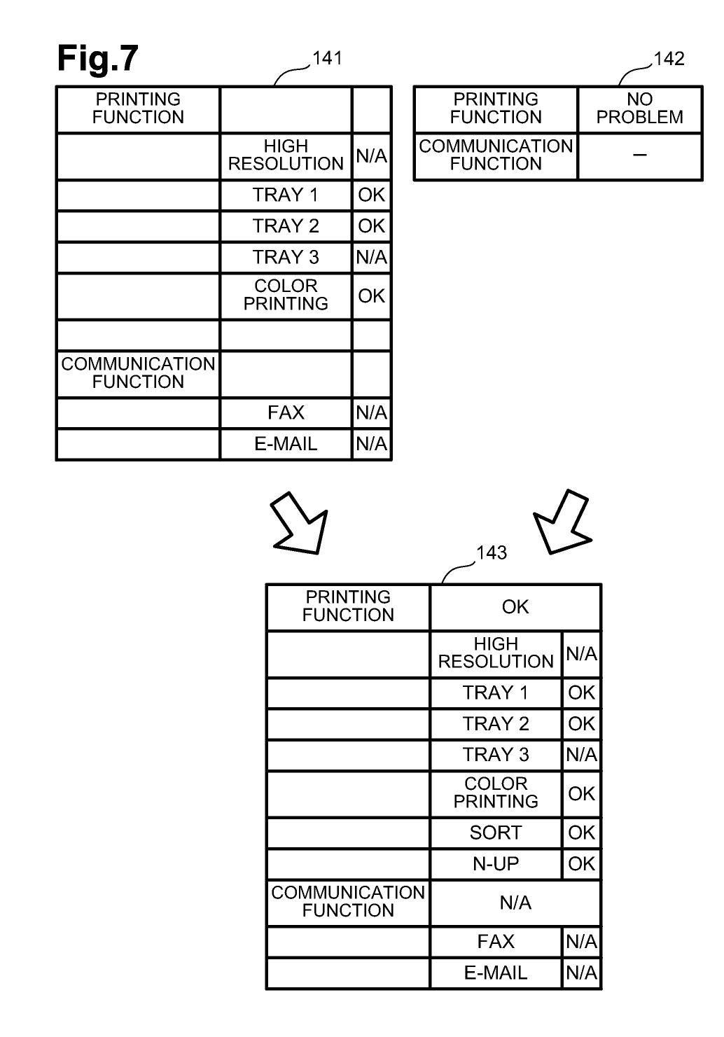

When scanner 100 establishes a connection with a printer of a model B (hereinafter, referred to as a “printer B”), CPU 11 may obtain specification information 141 and status information 142, as depicted in FIG. 7, CPU 11 subsequently may generate a functional profile 143 of FIG. 7, based on specification information 141 and status information 142, Printer B may have different options for a communication function than printer A (e.g., printer A has a facsimile function, whereas printer B does not have a facsimile function). In addition, the options of the printing function supported by printer B may be different from the options of the printing function supported by printer A (e.g., printer B has a tray 2 option, whereas printer A does not have a tray 2 option). As described above, CPU 11 may generate functional profile 143 in accordance with the model of the connection-target device.

CPU 11 may instruct operating panel 40 to display printer interface 41, as depicted in FIG. 3, based on functional profile 143 generated in step S122 at step S123. More specifically, CPU 11 may determine whether each of the printing function and the communication function is available, with reference to functional profile 143, and CPU 11 may instruct operating panel 40 to indicate the printing functions and the communication functions with graphics, such that available functions are distinguished from unavailable functions in printer interface 41. For example, the available function may be displayed in a first color, and the unavailable function may be displayed in a second color that is different from the first color. Referring to printer A (as depicted in FIG. 6) and printer B (as depicted in FIG. 7) as an example, copy graphic 411 and transfer graphic 412 may be displayed in the first color on printer interface 41 for printer A because both the printing function and the communication function may be available in printer A; and copy graphic 411 may be displayed in the first color and transfer graphic 412 may be displayed in the second color on printer interface 41 for printer B because the printing function may be available and the communication function may not be available in printer B. Accordingly, a user may notice that the transfer function may not be available by glancing at printer interface 41 when scanner 100 is connected with printer CPU 11 may wait for an input after displaying printer interface 41.

When CPU detects an input through operating panel 40, CPU 11 may determine whether operating panel 40 receives an input that selects cancel graphic 413 at step S124. When operating panel 40 receives an input that selects cancel graphic 413 (step S124:YES), CPU 11 may restore the display screen on operating panel 40 to the previous screen before initiating the external connection establishing process. CPU 11 subsequently may end the printer interface displaying process.

When operating panel 40 does not receive an input that selects cancel graphic 413 (step S124:NO), CPU 11 may determine whether operating panel 40 receives an input that selects one of the graphics of the available functions (e.g., one of copy graphic 411 and transfer graphic 412) through the user input at step S125. More specifically, CRU 11 may determine whether the term: “OK” has been assigned to the function selected in the functional profile. When operating panel 40 does not receive an input that selects one of the graphics of the available functions (e.g., a graphic corresponding to a function unavailable to the connection-target device is selected (step S125:NO)), CRU 11 may issue a warning at step S141, and the routine may return to step S123. In step S141, for example, CPU 11 may issue one or more of a warning message and an audible indication (e.g., a beep) indicating that the selected function is not available.

As described above, in step S123, the available functions and the unavailable functions may be displayed in the different colors, Nevertheless, in modified configurations, for example, the available function may be displayed as selectable, and the unavailable function may be displayed as unselectable, This configuration may be an example of distinguishably displaying the available function and the unavailable function. In this configuration, the unavailable function may be unselectable. Therefore, CPU 11 may skip step S125. In some configurations, the unavailable functions may not be displayed, such that the unavailable functions are unselectable. In other configurations, the unavailable functions may be dimmed on printer interface 41, such that the unavailable functions are unselectable.

When operating panel 40 receives an input that selects one of the graphics of the available functions (step S125:YES), CPU 11 may determine whether operating panel 40 receives an input that selects the copying function at step S126. When operating panel 40 receives an input that selects the copying function (e.g., when the copy graphic is selected (step S126:YES)), CRU 11 may perform a copying function interface displaying process for displaying a setting screen for a scanning and printing process (e.g., a copy function interface) on operating panel 40 at step S127. Step S127 is described in detail below.

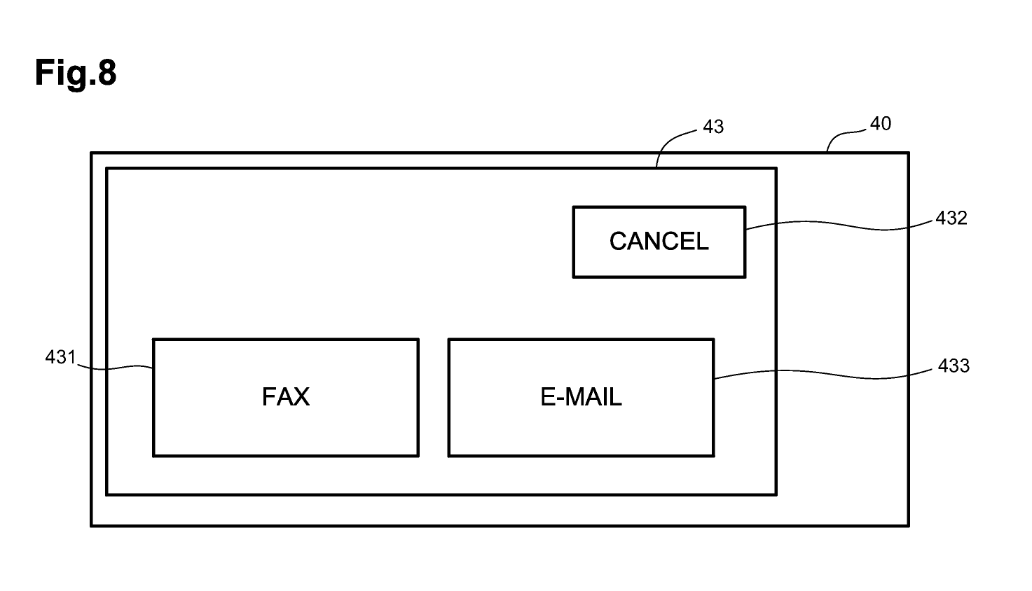

When the process reaches step S126 and when operating panel 40 receives an input that does not select the copying function (e.g., when transfer graphic 412 is selected (step S126:NO)), CPU 11 may instruct operating panel 40 to display a setting screen for a scanning and transferring process (e.g., a transfer function interface 43) at step S151, as depicted in FIG. 8.

Operating panel 40 may display a screen comprising the transfer function interface 43 that permits selection of one of a facsimile transfer function and an electronic mail transfer function, as depicted in FIG. 8. More specifically, transfer function interface 43 may comprise a facsimile transfer graphic 431, an electronic mail transfer graphic 433, and a cancel graphic 432. Selecting facsimile transfer graphic 431 may initiate the facsimile transfer function. Selecting electronic mail transfer graphic 433 may initiate the electronic mail transfer function. Selecting cancel graphic 413 may cancel the external connection establishing process. As depicted in FIG. 8, transfer function interface .43 may be an example of the setting screen for the scanning and transferring process and may not be limited to the configuration of transfer function interface 43 described above. In certain embodiments, for example, the setting screen for the scanning and transferring process may comprise other graphics for implementing other functions.

With reference to function profile 143 generated in step S122, CPU 11 my determine whether each of the facsimile transfer function and the electronic mail transfer function is available in the printer and may indicate the facsimile transfer function and the electronic mail transfer function in transfer function interface 43 with appropriately distinguished graphics (e.g., graphics distinguishing between available functions and unavailable functions). In a similar manner as described above with regard to printer interface 41, for example, operating panel 40 may indicate facsimile transfer graphic 431 and electronic mail transfer graphic 433 in one of the first color and the second color, based on the availability of the facsimile transfer function and the electronic mail transfer function in the printer,

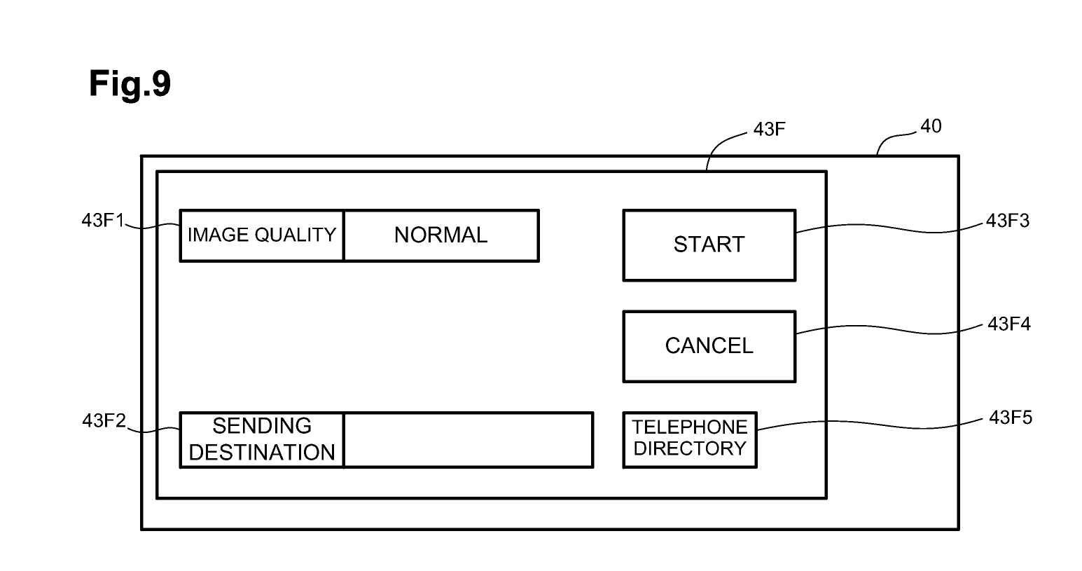

When operating panel 40 receives an input that selects facsimile transfer graphic 431 in transfer function interface 43, CPU 11 may display on operating panel 40 a setting screen for the scanning and transferring process of facsimile transfer function facsimile transfer function interface 43F), as depicted in FIG. 9. Operating panel 40 may display a setting screen comprising settings for scanner 100 when scanner 100 scans a document and transfers an image scanned from the document using the facsimile transfer function.

More specifically, facsimile transfer function interface 43F may comprise a facsimile function settings area 43F1, a destination settings area 43F2, a start graphic 43F3, a cancel graphic 43F4, and a telephone directory graphic 43F5. Facsimile function settings area 43F1 may be used for setting the facsimile function settings. Destination settings area 43F2 may be used for setting the destination settings. Selecting start graphic 43F3 may initiate scanning of a document. Selecting cancel graphic 43F4 may cancel the external connection establishing process. Selecting telephone directory graphic 43F5 may allow the selection of a destination from a telephone directory. Facsimile function settings area 43F1 may indicate the currently-selected. option of each item (e.g., image quality) of the facsimile function settings. As depicted in FIG. 9, facsimile transfer function interface 43F may be an example of the setting screen for the scanning and transferring process of the facsimile transfer function and may not he limited to the configuration of facsimile transfer function interface 43F. In certain embodiments, for example, the setting screen for the scanning and transferring process of the facsimile transfer function may comprise other graphics for implementing other functions.

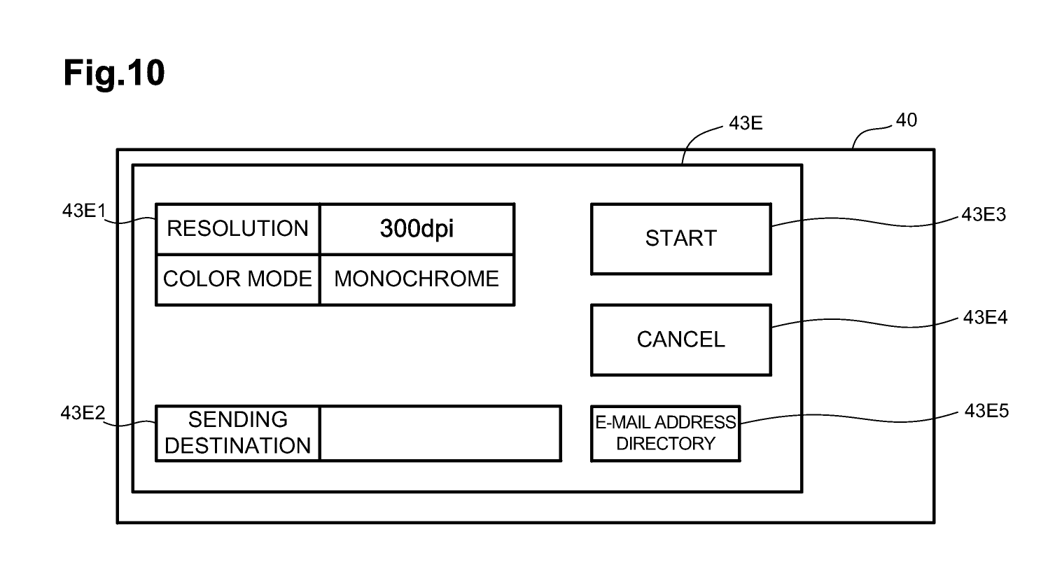

When CPU 11 determines that operating panel 40 receives an input that selects electronic mail transfer graphic 433 in transfer function interface 43, CPU 11 may instruct operating panel 40 to display a setting screen for the scanning and transferring process of electronic mail transfer function (e.g., electronic mail transfer function interface 43E), as depicted in FIG. 10. Operating panel 40 may display a screen comprising settings for scanner 100 when scanner 100 scans a document and transfers an image scanned from the document using the electronic mail transfer function.

More specifically, electronic mail transfer function interface 43E may comprise a scan settings area 43E1, a destination settings area 43E2, a start graphic 43E3, a cancel graphic 43E4, and an electronic mail address directory graphic 43E5. Scan settings area 43E1 may be used for setting the scan settings. Destination settings area 43E2 may be used for setting the destination settings. Selecting start graphic 43E3 may initiate scanning of a document. Selecting cancel graphic 43E4 may cancel the external connection establishing process. Selecting electronic mail address directory graphic 43E5 may allow the selection of a destination from an electronic mail address directory. Scan settings area 43E1 may indicate the currently-selected option of each item (e.g., resolution and color mode) of the scan settings. As depicted in FIG. 10, electronic mail transfer function interface 43E, as depicted in FIG. 10, may be an example of the setting screen for the scanning and transferring process of the electronic mail transfer function and may not be limited to the electronic mail transfer function interface 43E described above. In certain embodiments, for example, the setting screen for the scanning and transferring process of the electronic mail transfer function may comprise other graphics for implementing other functions.

According to FIG. 5, after each of steps S127 and S151, CPU 11 may end the printer interface displaying process. As described above, in the printer interface displaying process, CPU 11 may determine available options for displaying printer interface 41 in accordance with the performance capability and the status of the connection-target device. Consequently, operating panel 40 may indicate a function that may not be available in the connection-target device as distinguished from an available function. Although the unavailable function may be selected, CPU 11 may cancel an execution instruction for the unavailable function. Accordingly, this configuration may reduce instances in which a user issues to the connection-target device receives an instruction to execute a function unavailable to the connection-target device,

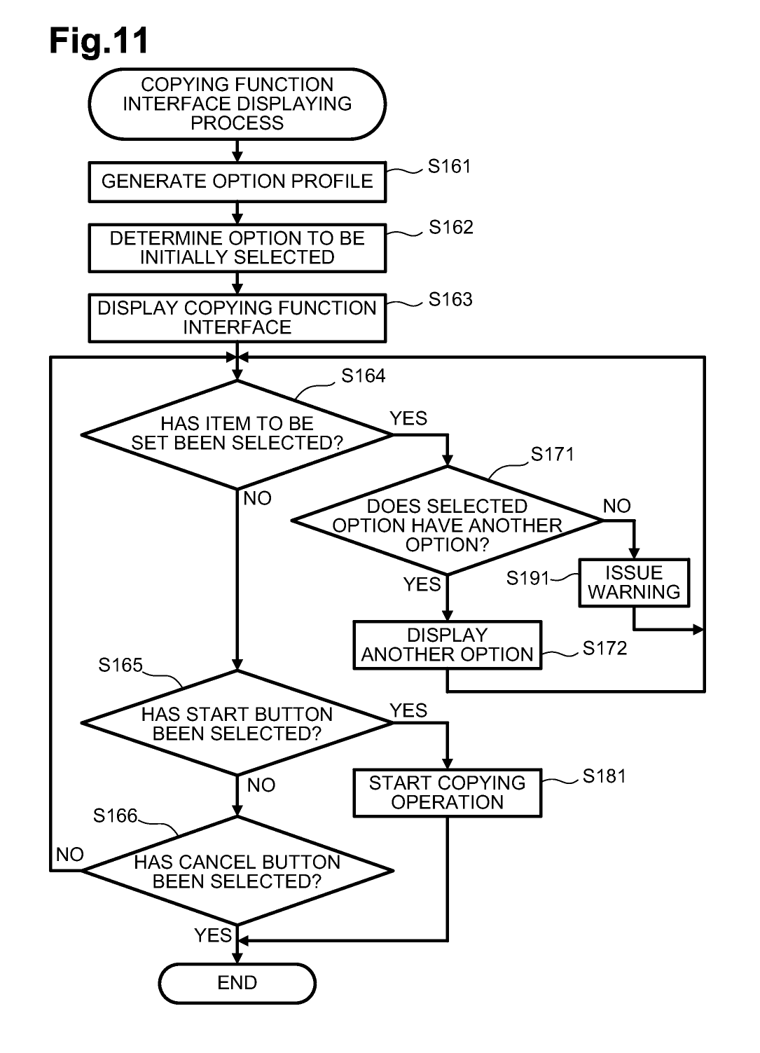

The copying function interface displaying process of step S127 of FIG. 5 now is described in more detail, with reference to FIG. 11. CPU 11 may perform the copying function interface displaying process.

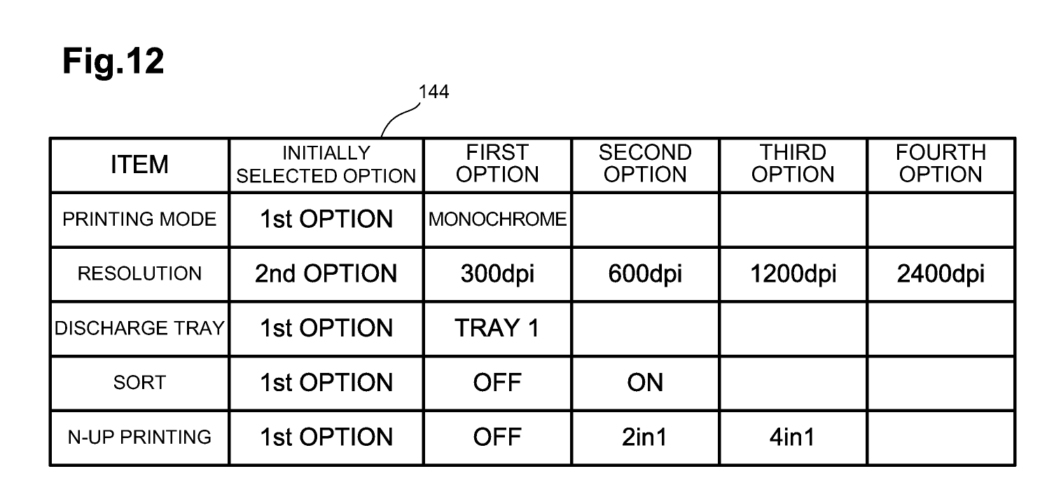

As depicted in FIG. 12, CPU 11 may generate an option profile 144 based on specification information 141, status information 142, and functional profile 143 at step S161, Referring to option profile 144, CPU 11 may determine an option for each item to be displayed on a copying function interface by selecting one or more options for each item, The items stored in option profile 144 may comprise, for example, “printing mode,” “resolution,” “discharge tray,” “sort,” and “N-up printing.”

More specifically, FIG. 12 depicts an option profile 144 of printer A (as described above, with reference to FIG. 6). Only one option (e.g., “monochrome”) may be available for “printing mode” because color printing may not be available in printer A (e.g., because cyan toner is empty in printer A), in addition, only one option “tray 1”) may be available for the “discharge tray” item because tray 2 and tray 3 may not be available for use in printer A. Four options (e.g., “300 dpi,” “600 dpi,” “1200 dpi,” and “2400 dpi”) may be available for the “resolution” item because high resolution printing may be available in printer A.

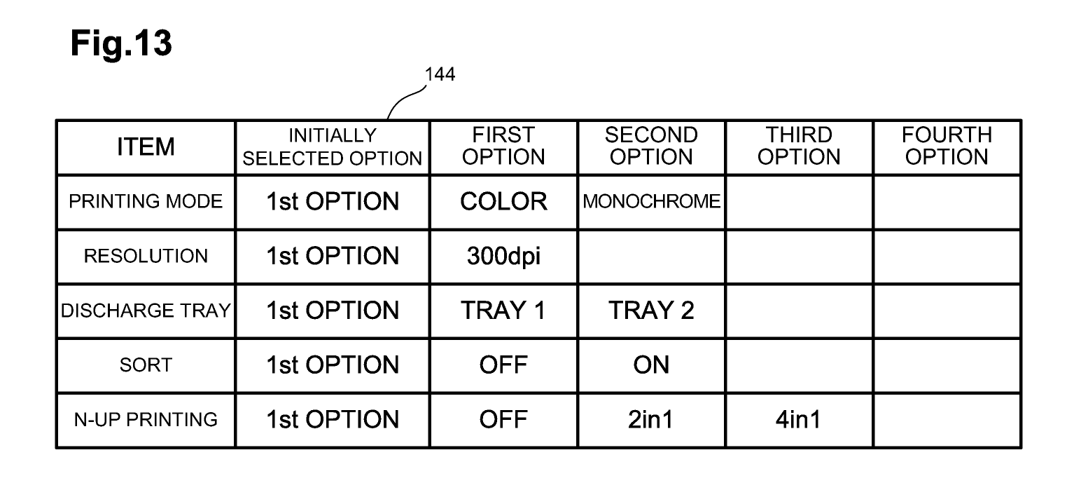

FIG. 13 depicts an option profile 144 of printer B (as described above, with reference to FIG. 7). Only one option (e.g., “300 dpi”) may be available for the “resolution” item because high resolution printing may not be available in printer B. Two options (c.o., “color” and “monochrome”) may be available for the “printing mode” item because color printing may be available in printer B. Two options (e.g., “tray 1” and “tray 2”) may be available for the “discharge tray” item because tray 2 may be available for use in printer B in addition to tray 1.

CPU 11 subsequently may determine an option to be selected initially for each item with a plurality of assigned options at step S162. For example, CPU 11 may retain the option data from a previous time when scanner 100 connected with the connection-target device. Initially, CPU 11 may select an option for each item associated with the connection-target device that was most frequently used during a previous time when scanner 100 connected with a connection-target device of the same model. Alternatively or additionally, in certain embodiments, scanner 100 may store priorities assigned to the plurality of options and initially select an option based on the stored priorities. In certain embodiments, scanner 100 may select a predetermined option initially. Alternatively or additionally, scanner 100 may select a random option initially from the plurality of options. CPU 11 may store the initially selected option in option profile 144.

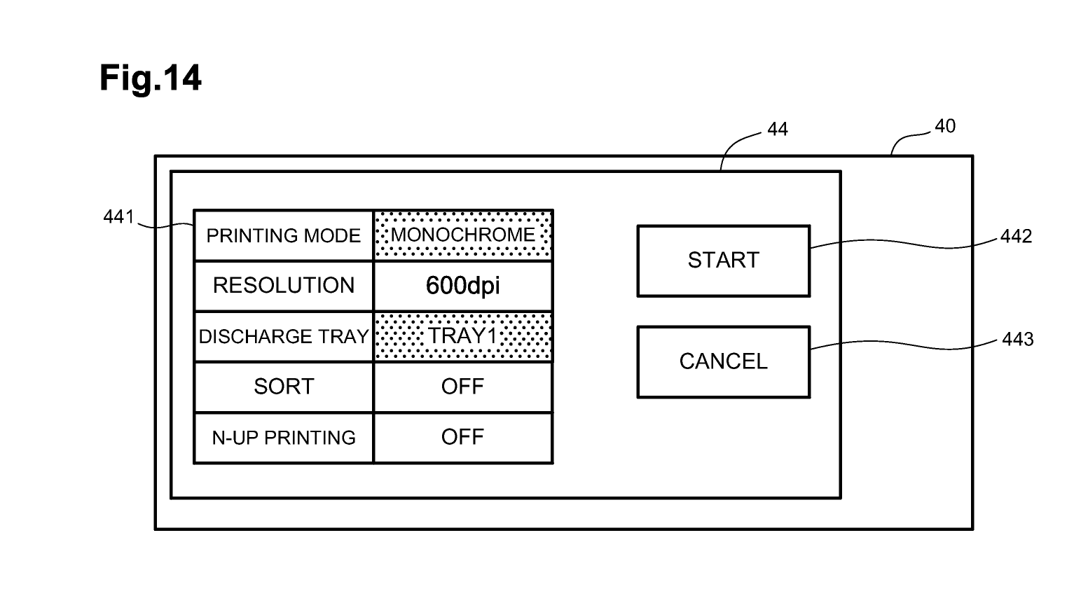

CPU 11 subsequently may display copying function interface 44 at step S163, as depicted in FIG. 14. Based on option profile 144, CPU 11 may list items that may be available for setting on copying function interface 44. More specifically, copying function interface 44 may comprise a printing settings area 441, a start graphic 442, and a cancel graphic 443. Printing settings area 441 may be used for setting the printing settings. Selecting start graphic 442 may initiate scanning of a document. Selecting cancel graphic 443 may cancel the external connection establishing process. As depicted in FIG. 14, copying function interface 44 may be an example of the setting screen for the scanning and printing process and may not be limited to the copying function interface 44 described above. In certain embodiments, for example, the setting screen for the scanning and printing process may compriseX other graphics for implementing other functions.

Printing settings area 441 may list options, which were selected initially from option profile 144, and the items (e.g., “printing mode,” “resolution,” “discharge tray,” “sort,” and “N-up printing”), which respectively correspond to the initially selected options. Items having only one available option may be displayed in a different manner than items having a plurality of available options because the items having only one available option may not he changed to another option. For example, items having only one available option may be displayed in the first color. Items having a plurality of available options may be displayed in the second color.

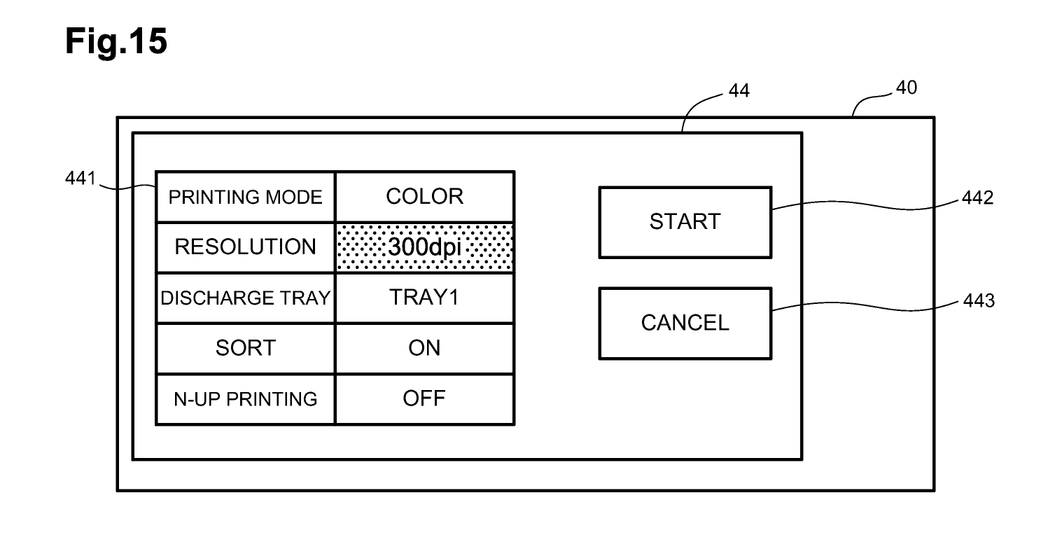

FIG. 14 depicts copying function interface 44 of printer A (as described above, with regard to FIG. 6). In printing settings area 441 corresponding to printer A, only one option (e.g., “monochrome”) be available for the “printing mode” item, and only one option “tray 1”) may be available for the “discharge tray” item. Therefore, these options may be displayed in the second color. A plurality of options may be available for each of the other items (e.g., “resolution,” “sort,” and “N-up printing”). Therefore, these options may be displayed in the first color. FIG. 15 depicts copying function interface 44 of printer B (as described above, with regard to FIG. 7). In printing settings area 441 corresponding to printer B, only one option (e.g., “300 dpi”) may be available for the “resolution” item, Therefore, the “300 dpi” option may be displayed in the second color.

When an input operation(e.g., touching a display area on operating panel 40) is performed to select one of the items listed in the printing settings area 441, another option may appear for the selected item, in place of the currently-selected option. When operating panel 40 receives an input that selects start graphic 442, CPU 11 may initiate a copying operation. When operating panel 40 receives an input that selects cancel graphic 43, CPU 11 may cancel the external connection establishing process. CPU 11 may wait for operating panel 40 to receive an input after displaying copying function interface 44.

After operating panel 40 receives an input, CPU 11 may determine whether operating panel 40 receives an input that selects an item for setting (e.g., a setting item) from the plurality of items listed in printing settings area 441 at step S164. When operating panel 40 receives an input that selects an item for setting (step S164:YES), CPU 11 may determine whether the selected item has another available option for setting in addition to the currently-selected option (e.g., the selected item has a plurality of available options) at step S171.

When the selected item has another available option for setting (step S1171:YES), CPU 11 may display the other available option at step S172. When the selected item has a plurality of other available options, CPU 11 may switch the currently-selected option to display one of the plurality of other available options based on the order of the plurality of the other available options listed in option profile 144. When the currently-selected option is a first option, the currently-selected option may, for example, be switched to a second option. When the currently-selected option is the second option, for example, the currently-selected option may be switched to a third option. When CPU 11 has cycled through each available option of the plurality of available options, CPU 11 may display the first option again as the currently-selected option. After CPU switches to an available option and operating panel 40 receives an input that selects the available option as a desired option, the routine may move to step S164.

When the selected item does not have another available option (step S171:NO), CPU 11 may issue a warning at step S191, and the routine may proceed to step S164. In step S164, for example, CPU 11 may issue one or more of a warning message and an audible alarm (e.g., a beep) indicating that the selected item does not have another option.

When an item to be set has not been selected (step S164:NO), CPU 11 may determine whether operating panel 40 receives an input that selects start graphic 442 at step S165. When operating panel 40 receives an input that selects start graphic 442 (step S165:YES), CPU 11 may initiate a copying operation in accordance with the settings specified in copying function interface 44 at step S181). In the copying operation, scanner 100 may start scanning a document and then may send image data corresponding to an image scanned from the document to printer 200, When printer 200 receives the image data, printer 200 may print the image data, thus completing the copy operation. After thus completing the copy operation, CPU 11 may end the copy function interface displaying process.

When operating panel 40 does not receive an input that selects start graphic 442 (step S165:NO), CPU 11 may determine whether operating panel 40 receives an input that selects cancel graphic 443 at step S166. When operating panel 40 receives an input that selects cancel graphic 443 (step S166:YES), CPU ii may end the copying function interface displaying process. When operating panel 40 does not receive an input that selects cancel graphic 443 (step S166:NO), the routine may move to step S164, and CPU 11 may wait for operating panel 40 to receive an input.

As described above, in the copying function interface displaying process, CPU 11 may determine available options for displaying the copying function interface 44 in accordance with the performance capability and the status of the connection-target device. Thus, functions unavailable in the connection-target device may not be contained in the available options. Items having only one available option may be displayed distinguishably from items having a plurality of available options, and the current option of the item having only one available option may not be switched to another option. Thus, the range of selection may be limited to the available options corresponding to each of the items, such that operating panel 40 does not receive an input that selects an unavailable option. Accordingly, this configuration may reduce instances in which a user issues to the connection-target device an instruction to execute a function unavailable to the connection-target device.

As described above, in scanner 100, the options available for each item that may appear on the setting screen may be changed in accordance with the performance capability and status of the connection-target device. More specifically, functions unavailable m the connection-target device may not be comprised in the available options for setting and functions available in the connection-target device may be comprised in the options available for setting. This configuration may facilitate identification of items having options that may be available for change.

It will be understood by those of ordinary skill in the art that other variations and modifications of embodiments described above may be made. Other embodiments will be apparent to those of ordinary skill in the art from a consideration of the specification. Nevertheless, the specification and the described examples are considered as exemplary only. The scanning device may apply to one or more of multifunction peripherals having a scanning function and facsimile machines having a scanning function, as well as scanners.

In the foregoing embodiments, scanner 100 may obtain performance capability data related to the connection-target device (e.g., printer 200) by inquiring directly of printer 200. In certain embodiments, scanner 100 may obtain performance capability data related to the connection-target device in another manner. When a server, or even scanner 100 itself, has a database comprising performance capability data of printers by model, scanner 100 may be configured to obtain the performance capability data from the database. When the server manages the status of printer 200, scanner 100 may be configured to obtain the status of printer 200 from the server.

In foregoing embodiments, scanner 100 may determine the availability of the functions and the details of the options, based on both the specification information and the status information. In certain embodiments, for example, scanner 100 may determine the availability of the functions and the details of the options based on one of the specification information and the status information. For example, the available options may be limited to functions supported by the connection-target device, based on the specification information, without the status information. When scanner 100 obtains detailed status information about the functions status information about each item, such as double-sided printing, high resolution printing, and color printing of the printing function), the range of selection may be limited to the available options, based on the status information, without the specification information. The scanner 100 may determine available options with more precision, based on both of the specification information and the status information.

In foregoing embodiments, scanner 100 may initiate a scanning operation after the setting for printing is completed. In certain embodiments, scanner 100 may, for example, perform the setting for printing after completing the scanning operation. Thus, scanner 100 may complete the scanning operation and then perform the external connection establishing process.

In foregoing embodiments, the available functions and the unavailable functions may be displayed in the different colors to be distinguished from each other. in certain embodiments, the available functions and the unavailable functions may not be distinguishably displayed. Thus, when the unavailable function is selected, scanner 100 may issue a warning with one or more of audible tones (e.g., beep tones) and a warning message, such that the unavailable function may not be selected.

While the invention has been described in connection with various exemplary structures and illustrative embodiments, it will be understood by those skilled in the art that other variations and modifications of the structures, configurations, and embodiments described above may be made without departing from the scope of the invention. For example, this application comprises any possible combination of the various elements and features disclosed herein, and the particular elements and features presented in the claims and disclosed above may be combined. with each other in other ways within the scope of the application, such that the application should be recognized as also directed to other embodiments comprising other possible combinations. Other structures, configurations, and embodiments will be apparent to those skilled in the art from a consideration of the specification or practice of the invention disclosed herein. It is intended that the specification and the described examples are illustrative with the true scope of the invention being defined by the following claims.

What is claimed is:

1. A scanner configured to establish a connection with a connection-target device, the scanner comprising:
a scanning device configured to scan a document;
a display; and
a control device configured to:
obtain at least one of specification information and status information corresponding to a connection-target device,
wherein the specification information comprises information identifying available functions of the connection-target device, and
wherein the status information comprises information indicating a current status of the connection-target device;
control the display to display a setting screen for a scanning and printing process, in which the scanning device is configured to scan an image on a document and to send image data corresponding to the image on the document to the connection-target device for printing, when the connection-target device is a printer; and
determine one or more available options for at least one of a plurality of setting items displayed on the setting screen for the scanning and printing process, based on the obtained at least one of the specification information and the status information corresponding to the connection-target device.

2. The scanner according to claim 1, wherein the control device is further configured to obtain the specification information corresponding to the connection-target device by requesting the connection-target device to provide information regarding the specification information.

3. The scanner according to claim 2, wherein the control device is further configured to obtain the status information corresponding to the connection-target device by requesting the connection-target device to provide information regarding the status information.

4. The scanner according to claim 1, wherein the control device is further configured to:
determine whether the connection-target device is a printer or an information processing device, in which a printing function is not available; and
control the display to display a setting screen for a scanning and storing process, in which the scanning device is configured to scan an image on a document and to store image data corresponding to the image on the document in the connection-target device, when the connection-target device is an information processing device, in which a printing function is not available.

5. The scanner according to claim 1, wherein the control device is further configured to:
determine the one or more available options for the at least one of the plurality of setting items displayed on the setting screen, such that a setting of a setting item related to a facsimile function is available for selection, when the facsimile function is a currently available function of the connection-target device; and
determine the one or more available options for the at least one of the plurality of setting items displayed on the setting screen, such that a setting of a setting item related to the facsimile function is unavailable for selection, when the facsimile function is not a currently available function of the connection-target device

6. The scanner according to claim 1, wherein the control device is further configured to:
determine the one or more available options for the at least one of the plurality of setting items displayed on the setting screen, such that a setting of a setting item related to an electronic mail function is available for selection, when the electronic mail function is a currently available function of the connection-target device; and
determine the one or more available options for the at least one of the plurality of setting items displayed on the setting screen, such that a setting of a setting item related to the electronic mail function is unavailable for selection, when the electronic mail function is not a currently available function of the connection-target device.

7. An image forming system comprising:
a connection-target device; and
a scanner configured to establish a connection with the connection-target device, the scanner comprising:
a scanning device configured to scan a document;
a display; and
a control device configured to:
obtain at least one of specification information and status information corresponding to the connection-target device,
wherein the specification information comprises information identifying available functions of the connection-target device, and
wherein the status information comprises information indicating a current status of the connection-target device;
control the display to display a setting screen for a scanning and printing process, in which the scanning device is configured to scan an image on a document and to send image data corresponding to the image on the document to the connection-target device for printing, when the connection-target device is a printer; and
determine one or more available options for at least one of a plurality of setting items displayed on the setting screen for the scanning and printing process, based on the obtained at least one of the specification information and the status information corresponding to the connection-target device.

8. A method of controlling a scanner that comprises a scanning device and is configured to establish a connection with a connection-target device, the method comprising:
obtaining at least one of specification information comprising information identifying available functions of a connection-target device and status information comprising information indicating a current status of the connection-target device;
controlling a display to display a setting screen for a scanning and printing process, in which a scanning device scans an image on a document and sends image data corresponding to the image on the document to the connection-target device for printing, when the connection-target device is a printer; and
determining one or more available options for at least one of a plurality of setting items displayed on the setting screen for the scanning and printing process, based on the obtained. at least one of the specification information and the status information.
